(19) United States
(12) Patent Application Publication
(10) Pub. No.: US 2018/0349972 A1
(43) Pub. Date: Dec. 6, 2018

(54) SYSTEM AND METHOD FOR FACILITATING REVERSE AUCTION PROCESS

(71) Applicants: Deepshikha KALRA, Gurgaon (IN); Saroj Bala KALRA, Gurgaon (IN)

(72) Inventors: Deepshikha KALRA, Gurgaon (IN); Saroj Bala KALRA, Gurgaon (IN)

(21) Appl. No.: 15/779,133

(22) PCT Filed: Nov. 23, 2016
(86) PCT No.: PCT/IB2016/057051

§ 371 Date: May 25, 2018

(30) Foreign Application Priority Data
Dec. 31, 2015 (IN) 4352/DEL/2015

(51) Int. Cl. G06Q 30/06; G06Q 20/12

(52) U.S. Cl. CPC G06Q 30/0611; G06Q 20/12; G06Q 30/0609

(57) ABSTRACT

Provided are a system and method for facilitating reverse auction process. The system includes a server configured to acquire input conditions by a user intending to get the service, and collect a plurality of pieces of bid information input by at least one service provider. The server is also configured to provide the user with a piece of bid information satisfying the input conditions based on which a winning bidder is determined The server is configured to receive the completed product pertaining to the service from the winning bidder and deliver it to user. The server is further configured to cross-verify the delivered product and handles any dispute therein.

### FIELD OF THE INVENTION

The present invention relates to a computer system and method for getting services, and more particularly to a computer system and method for getting services using reverse auction mechanism.

### BACKGROUND OF THE DISCLOSURE

It can be imagined that the most basic buying and selling scheme may be a scheme in which a user directly buys his/her desired product/service from a seller/service provider. In this case, mostly the service provider unilaterally decides the pricing, and the user does not have much control over the whole scheme. One other alternate buying and selling scheme is auctioning scheme. In one type of auction, known as a forward auction, the price for a product or service is bid up by buyers, of which the highest bidder is the buyer of the product or service. Again this type of auction tends to favor the service provider or vendor because the process tends to make the buyer pay a higher price for the product or service in order to win the bid over the other potential buyers. One other type of auction scheme is reverse auction in which the roles of buyer and seller are reversed. In a reverse auction, the sellers compete to obtain business from the buyer and prices will typically decrease as the sellers undercut each other.

While the requirements and the satisfying condition for each service may vary based on type of needs, location, date and many more factors, but in almost all cases the broad set of steps that are taken by user remains same. In order to get these services, the user reaches vendor/service providers either by visiting internet search, using contacts and/or taking referral from others. To get the best service for the money spent, the user then drafts his/her requirements, and negotiate price with one or more vendor/service providers, and then after completion of services pays the vendor/service provider as per the agreement. In this process, user is not only responsible for drafting his/her requirements, but also reaching vendor/service providers. Such process is not very much oriented towards user, as the user has to do a lot of search and study of market before making his offer. In addition, it is user's responsibility to compute if the offer is best for the services or not. Further, to carry out any such scheme, the user, usually, has to visit a store to collect information, select the service, receive bids, negotiate the price, etc. In other words, the existing methods provide inconvenience to users, resulting in reduction of customer satisfaction.

One approach that has gained popularity in recent years is the electronic reverse auction. These electronic resources allow for automating the negotiation process between the user and service providers in order to provide the user with the lowest price for the required service. This removes the user from the actual negotiation process, and generally requires the service providers to place price quotes over a set period of time. This way the user has a series of firm price quotes from which the purchase of the service can follow.

However current methods of conducting the reverse auction over a computer network, such as the Internet, have some deficiencies. For example, the user may be in need of a service for a first time and do not have necessary skills to determine if the proposal provided by the service providers, acting as bidders, may be adequate enough for proper and satisfactory completion of the required service. Using the currently available e-auctioning means, the user may be able to receive the lowest bid for completion of the required services by a service provider, however the current means do not provide any verification mechanism to assist the user to determine if the proposed plan by the winning bidder is acceptable for satisfying the conditions of the requested service(s).

Therefore, there is a need of a technological method that makes it possible to provide a user-oriented process to get services and further assist the user to choose the right service provider.

### SUMMARY OF THE INVENTION

Embodiments of the present invention aim to provide a method for facilitating reverse auction comprising the steps of: obtaining plurality of pieces of information inputted by a user by an acquisition module; collecting plurality of bids provided by a plurality of service providers by a collection module; determining a lowest bid of said provided bids by said service providers by a control module; notifying the winning bidder by a notification module; receiving a communication between said user and said service provider by a communication module; and purchasing said bid by said user by means of payment module; wherein said user and said service provider are optionally connected by a server.

In accordance with an embodiment of the present invention the method further comprising a step of interacting said user and said service provider with said server by a device.

In accordance with an embodiment of the present invention the method comprises service providers and users communicate with each other in a peer-to-peer manner, over a network or on a communication interface.

In accordance with an embodiment of the present invention the method comprises collection module configures said server to automatically bid for said service providers.

In accordance with an embodiment of the present invention the method comprises control module configures the server to compute the condition for the bids that satisfies the minimum requirements acquired by the acquisition module.

In accordance with an embodiment of the present invention the method having control module provides said user with the plurality of piece of bid information, from the participating service providers, satisfying the inputted conditions for the requested service.

In accordance with an embodiment of the present invention the method wherein user selects the winning bidder from the plurality of service providers based on the shared pieces of information by the control module.

In accordance with an embodiment of the present invention the method wherein said control module automatically selects the winning bidder based on the bid with the minimum price quote, as received from the plurality of service providers.

In accordance with an embodiment of the present invention the method wherein said server rates said users and the service providers based on their profile information and history on the platform.

In accordance with an embodiment of the present invention the method wherein said method further comprising a step of authenticating and authorizing of the users and the service providers by a verification module implemented by the server.

In accordance with an embodiment of the present invention the method wherein said verification module configures said server to provide rights for authorization to services such as editing requirements, changing profiles and marking an auction close.

In accordance with an embodiment of the present invention the method wherein the verification module performs said authorization process for the users and the service providers to allow transmission and receiving of information that is allowed to be shared.

In accordance with an embodiment of the present invention the method wherein said user communicates to said winning service provider the specific requirements of the service by means of the communication module.

In accordance with an embodiment of the present invention the method comprises wherein said payment module facilitates payment between the users and the service providers after successful completion of the task based on the service requirement.

In accordance with an embodiment of the present invention the method wherein said method further comprising a step of performing smart searches of service providers that may suit the service requested by said user by an analysis module implemented by said server.

In accordance with an embodiment of the present invention the method wherein said method further comprising a step of verifying the delivered product or service by the winning bidder by a cross-verification module implemented by said server.

In accordance with an embodiment of the present invention the method wherein said method further comprising a step of monitoring a response of an expert panel on the delivered product by said service providers by a dispute handling module implemented by said server.

In accordance with an embodiment of the present invention the method wherein said method further comprising a step of matching a requested service to an old service requests by an automation module implemented by said server.

In accordance with an embodiment of the present invention the method wherein control module determines the bids as lowest bid, bid from highest rated professional, bids with maximum conditions met, bids with additional conditions.

In accordance with an embodiment of the present invention the method wherein the collection module receives the bid from the service providers till the termination conditions for the service request as defined by the user have been met which is checked by control module.

Embodiments of the present invention aim to provide a system for facilitating reverse auction process comprising: plurality of user; plurality of service providers; plurality of server configured to connect said user and said service provider; a set of module implemented by said server to perform reverse auction process comprising: an acquisition module to configure said server to obtain plurality of pieces of information inputted by said user; a collection module to configure said server to collect plurality of bids posted by said service providers, a communication module to configure said server to provide a platform for the communication between the users and the service providers; a control module to configure said server to determine the winner of the auction; a reviews and rating module to configure said server to rate said users and the service providers; a notification module to configure said server to notify the information about a service request, provided by said user, to all concerned service providers with selected bids; and a payment module to configure said server to make financial transactions.

In accordance with an embodiment of the present invention the system wherein said system further comprises a device for said user and said service provider to interact with said server.

In accordance with an embodiment of the present invention the system wherein said device includes personal computers, tablet computers, smartphones, PDAs, voice recognition devices, gaming devices or the like.

In accordance with an embodiment of the present invention the system wherein said service providers and users communicate with each other in a peer-to-peer manner, over a network or on a communication interface.

In accordance with an embodiment of the present invention the system wherein said collection module configures said server to automatically bid for said service providers.

In accordance with an embodiment of the present invention the system wherein said control module configures the server to compute the condition for the bids that satisfies the minimum requirements acquired by the acquisition module.

In accordance with an embodiment of the present invention the system wherein system further comprising a processing unit, a system memory and a system bus.

In accordance with an embodiment of the present invention the system wherein the control module provides the user with the plurality of piece of bid information, from the participating service providers, satisfying the inputted conditions for the requested service.

In accordance with an embodiment of the present invention the system wherein the piece of information includes quoted bid price, experience of the service provider, reviews and ratings/rankings of the service provider and combination thereof.

In accordance with an embodiment of the present invention the system wherein the user selects the winning bidder from the plurality of service providers based on the shared pieces of information by the control module.

In accordance with an embodiment of the present invention the system wherein said control module automatically selects the winning bidder based on the bid with the minimum price quote, as received from the plurality of service providers.

In accordance with an embodiment of the present invention the system wherein said server rates said users and the service providers based on their profile information and history on the platform.

In accordance with an embodiment of the present invention the system wherein the system further comprises a verification module to configure said server to perform authentication and authorization of the users and the service providers.

In accordance with an embodiment of the present invention the system wherein the verification module configures said server to provide rights for authorization to services such as editing requirements, changing profiles and marking an auction close.

In accordance with an embodiment of the present invention the system wherein the verification module performs said authorization process for the users and the service providers to allow transmission and receiving of information that is allowed to be shared.

In accordance with an embodiment of the present invention the system wherein said user communicates to said winning service provider the specific requirements of the service.

In accordance with an embodiment of the present invention the system wherein said payment module facilitates payment between the users and the service providers after successful completion of the task based on the service requirement.

In accordance with an embodiment of the present invention the system wherein the system further comprises an analysis module to configure said server to perform smart searches of service providers that may suit the service requested by said user.

In accordance with an embodiment of the present invention the system wherein the system further comprises a cross-verification module to configure said server to verify the delivered product by the winning bidder.

In accordance with an embodiment of the present invention the system wherein the system further comprises a dispute handling module to configure said server to monitor the response of an expert panel on the delivered product by said service providers.

In accordance with an embodiment of the present invention the system wherein the system further comprises an automation module to configure said server to match a requested service to an old service requests.

In accordance with an embodiment of the present invention the system wherein the system further comprises a system memory which is selected from one or more memory devices such as RAM.

In accordance with an embodiment of the present invention the system wherein said server includes a storage medium selected from a group of solid state storage device, a magnetic hard disk drive, a magnetic hard disk, a magnetic disk drive, an optical disk drive, a flash memory and combination thereof.

In accordance with an embodiment of the present invention the system wherein control module determines the bids as lowest bid, bid from highest rated professional, bids with maximum conditions met, bids with additional conditions.

In accordance with an embodiment of the present invention the system wherein the collection module receives the bid from the service providers till the termination conditions for the service request as defined by the user have been met which is checked by control module.

Another embodiments of the present invention aim to provide a system for facilitating reverse auction comprising a review and rating module configured to receive a plurality of reviews and ratings from a plurality of reviewers of plurality of users and service providers wherein said rating module sets a rank based on said plurality of reviews and ratings.

In accordance with an embodiment of the present invention the system wherein said reviews can be positive, negative or neutral.

In accordance with an embodiment of the present invention the system wherein said review and rating module sets highest ranking to the maximum positive reviews.

In accordance with an embodiment of the present invention the system wherein said reviews is based on a profile such as previous work, description, reputation, ranking, rating, review score(s), number of previous sales, payment methods accepted, condition of previously delivered items, location, speed of delivery, local delivery availability, local pickup availability, auxiliaries such as warranties and/or guarantees and combination thereof.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawing illustrates only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a schematic diagram for a computer system for getting a service using a reverse auction mechanism, in accordance with an embodiment of the present disclosure;

FIG. 2 illustrates a schematic diagram of a server, in accordance with an embodiment of the present disclosure;

FIG. 3 illustrates a block diagram of a set of software modules implemented by the server, in accordance with an embodiment of the present disclosure; and

FIG. 4 illustrates a flow chart for a method for carrying out the reverse auction mechanism, in accordance with an embodiment of the present disclosure.

### DETAILED DESCRIPTION OF THE DRAWINGS

Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a representative basis for teaching one skilled in the art to variously employ the present disclosure in any appropriate process.

Meanwhile, the terms used herein are for the purpose of describing exemplary embodiments only and are not intended to be limiting. As used herein, the singular forms “a,” “an,” and “the” are intended to include the plural forms as well, unless the context clearly indicates otherwise. It will be further understood that the terms “comprises” or “comprising,” when used in this specification, do not preclude the presence or addition of one or more components, steps, operations, and/or elements other than a mentioned component, step, operation, and/or element. It will be further understood that the term plurality will be construed “one or more”.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the Internet.

The detailed description which follows is represented largely in terms of processes and symbolic representations of operations in a distributed computing environment by conventional computer components, including remote file servers, remote computer servers, remote memory storage devices, a processing unit, memory storage devices, display devices and input devices. Each of these conventional distributed computing components is accessible by the processing unit via a communications network.

The processes and operations performed by the computer include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes a computer program which embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text. Therefore, disclosure of a particular set of program code instructions is not considered necessary for an adequate understanding of how to make and use the invention. The inventive functionality will be explained in more detail in consideration of the following description read in conjunction with the appended figures.

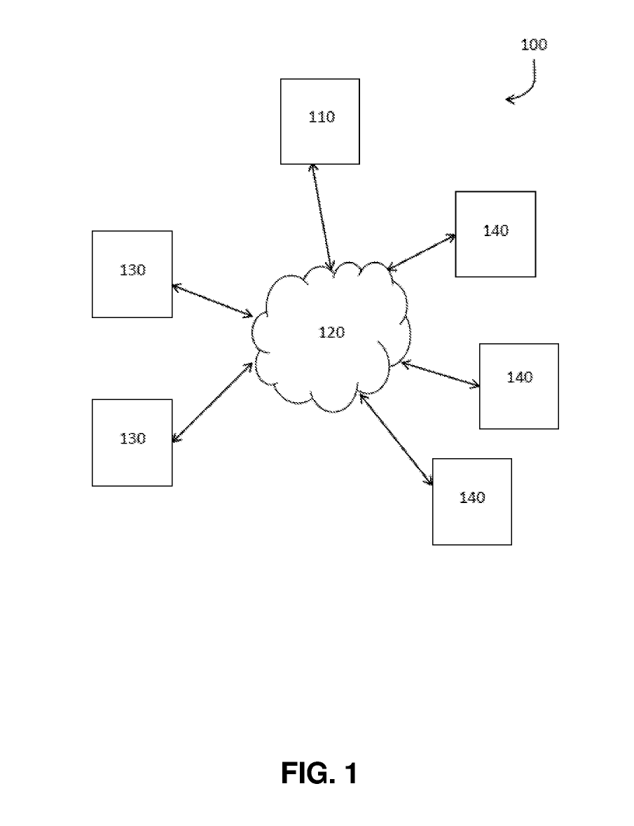

FIG. 1 illustrates a computer system 100 according to an embodiment of the present disclosure. The computer system 100 for implementing present processes may include, but not limited to, a reverse auctioning server, hereinafter simply referred to as server and numerically indicated by 110. In an embodiment of the present disclosure, the server 110 may be configured to connect buyers/users and vendors/service providers through a network 120, such as, but not limited to, the Internet. In one example, as illustrated in FIG. 1, the users and the service providers may be able to interact with the server 110 via user devices 130 and service provider devices 140, respectively. Although only one server 110 has been shown in FIG. 1, it may be contemplated that plurality of such servers may be employed, working in conjunction, without limiting the scope of the disclosure.

The server 110 that communicates over the network 120 with the user devices 130 and the service provider devices 140 may include, but not limited to, general-purpose computers, special-purpose computers, mainframes, or any processor-based device. The server 110 may be implemented as a network of computer processors. In some implementations, the server 110 may be multiple servers, mainframe computers, networked computers, a processor-based device, or a similar type of system or device. In other implementations, the server 110 may include a server farm or data center. The server 110 may receive connections through a load-balancing server or servers. In some implementations, a task may be divided among multiple servers 110 that are working together cooperatively. Further, in one example, the user devices 130 and the service provider devices 140 may include, but not limited to, personal computers, tablet computers, smartphones, PDAs, voice recognition devices, gaming devices or the like.

It may be contemplated that the user devices 130 and the service provider devices 140 may communicate with the server 110 through a web site or through another type of software interface, hosted on the server 110 and/or the network 120. The devices 130, 140 may communicate with the server 110 through one or more applications including computer-executable instructions. Alternative embodiments may not involve a network at all, and may instead be implemented on a standalone device used by the user(s). In some alternate embodiments, the user devices 130 and the service provider devices 140 may communicate with each other in a peer-to-peer manner, without requiring the network 120, with the instructions to carry out the reverse auction implemented in the devices 130, 140. Various embodiments employing software and/or web implementations are accomplished with standard programming techniques.

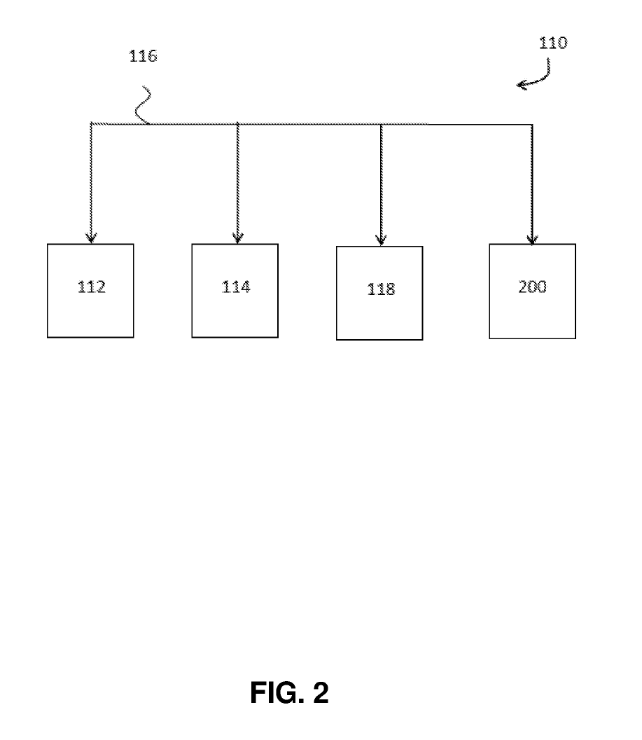

FIG. 2 illustrates a detailed structure of the server 110, in accordance with some embodiments of the present disclosure. As shown in FIG. 2, the server 110 may be implemented in the form of a conventional computer, including a processing unit 112 or processor, a system memory 114, and a system bus 116 that couples various system components including the system memory 114 to the processing unit 112. The system memory 114 may include one or more suitable memory devices such as, but not limited to, RAM. Further, the server 110 may also include a storage medium 118, such as, but not limited to, a solid state storage device and/or a magnetic hard disk drive (“HDD”) for reading from and writing to a magnetic hard disk, a magnetic disk drive for reading from or writing to a removable magnetic disk, and an optical disk drive for reading from or writing to removable optical disk such as a CD-RW or other optical media, flash memory, etc. The storage medium 118 may be external to the computer, such as external drive(s), external server(s) including database(s), or the like. The drives and their associated computer-readable media may provide non-transient, non-volatile storage of computer-executable instructions, data structures, program modules, and other data for the computer to function in the manner described herein.

In an embodiment of the present disclosure, the computer system 100 may be configured for delivering services using a reverse auction method. For this purpose, the computer system 100 may provide a set of software modules 200 implemented by the server 110, as schematically illustrated in FIG. 2. The set of software modules 200 may configure the server 110 to perform a variety of functions related to the reverse auctioning mechanism. It may be understood that the set of software modules 200 may be program code stored in the storage medium 118 and/or transiently stored in system memory 114.

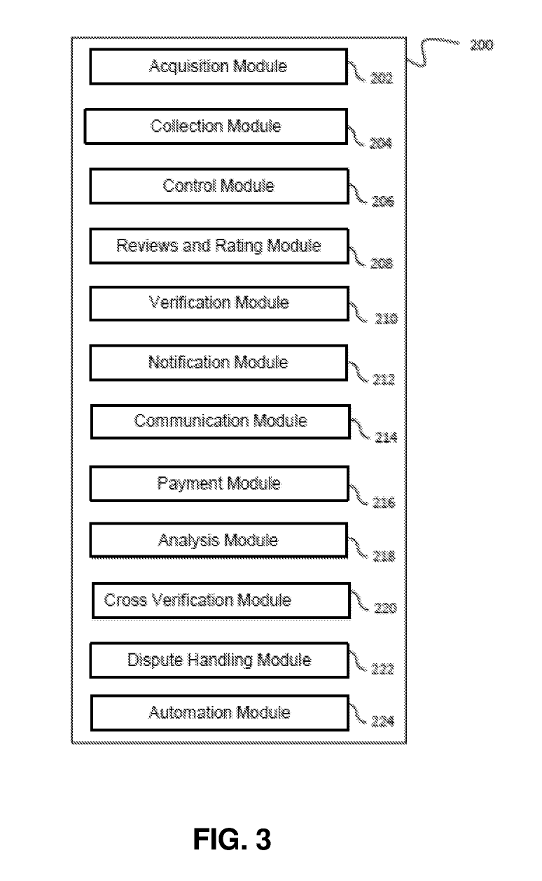

FIG. 3 illustrates a block diagram of the set of software modules 200 schematically representing various modules therein. As illustrated in FIG. 3, the set 200 may include an acquisition module 202 which may configure the server 110 to acquire plurality of pieces of information inputted by the user, via the user devices 130, pertaining to the requested service acquisition module 202 collects and stores a plurality of auction ordering information pieces received via on-line circuits such as the Internet. These auction ordering information pieces have been sent from a plurality of users. The acquired information may include details such as service-related profession, end date and time of service, the location of service, the budget for the service, the range of offerings expected in the service, etc. The user inputs the information by a input device, such as a keyboard or a pointing device (mouse, pen or the like), used by an operator to input information.

It may be contemplated by a person skilled in the art that the said details are exemplary only, and these details may vary according to the type of service. The set 200 may further include a collection module 204 which may configure the server 110 to collect plurality of bids as posted by the service providers, via the service provider device 140, for completing the requested service. In one example, the collection module 204 may configure the server 110 to automatically bid for the service provider. For example, the service provider/bidder may post an initial bid and also set a lowest amount as the bid. If someone outbid him/her, the collection module 204 may automatically lower the bid by a certain amount to put back his/her bid on top until the set lowest amount is met. The collection module 204 may further configure the server 110 to receive pieces of information from the service providers/bidders about specific details such as professional experience relevant to the requested service, digital copies of previous work samples, etc.

The set 200 may further include a control module 206 which may configure the server 110 to determine the winner of the auction. The control module 206 may configure the server 110 to compute the condition for the bids that satisfies the minimum requirements acquired by the acquisition module 202. In one example, the control module 206 provides the user with the plurality of piece of bid information, from the participating service providers, satisfying the inputted conditions for the requested service. The pieces of information may include the quoted bid price, experience of the service provider, reviews and ratings/rankings of the service provider, etc. The user may, then, select the winning bidder from the plurality of service providers based on the shared pieces of information. In other example, the control module 206 may automatically select the winning bidder by processing the pieces of information by predefined algorithms, where the algorithms may be defined to prioritize one aspect of the pieces of information over other as per the users requirement. In other example, the control module 206 may automatically select the winning bidder based on the bid with the minimum price quote, as received from the plurality of service providers.

In addition, the set 200 may include a reviews and rating module 208. The reviews and rating module 208 may configure the server 110 to review and rate and/or rank the listed users and the service providers based on their profile information and history on the platform. The reviews, ratings and rakings can be either overall and/or subject wise. For example, the reviews and rating module 208 may configure the server 110 to provide high rating/ranking to the service providers who have received positive feedback from the users on previously completed projects. For example, for all users that rate may not be equal when based on their experience with respective service providers. Further, the user can provide feedback for the service Therefore, all positive rating or negative rating cannot be evaluated based on their mere experience. There can be a weighted value for each service providers which may rely on ratings based on user's total experience, capability to evaluate the situation, his past experience in the area, his reviews and ratings and many more. Therefore, reviews and rating module 208 may configure the server 110 to use reviews, ratings, and other inputs to conclude this weighted value.

In accordance with an embodiment of the present invention, the review and rating module is configured to receive a plurality of reviews and a plurality of ratings from a plurality of reviewers. The present inventions also allow reviews and rating module to evaluate the ratings, reviews and lead quality based on provided information prior to providing a bid. A user may request additional information from the vendor/service provider in order to increase the vendor rating and lead quality. If the vendor or service provider rating or lead quality is not sufficient, a user may choose not to participate in an on-line reverse auction and negotiation process. The review and rating module may collect ratings, and reviews of vendor (based on the profile such as previous work, description, reputation, ranking, rating, review score(s), number of previous sales, payment methods accepted, condition of previously delivered items, location, speed of delivery, local delivery availability, local pickup availability, and auxiliaries such as warranties and/or guarantees). The reviews and ratings may be converted into ranking of the vendors. They may be given a single ranking or a subject wise ranking or ranking based on any mode adaptable. The reviews and rating module may take into consideration some more facts other than reviews and ratings to come up with the rank. This also includes to verify how accurate rating and reviews are for the vendors. Reviews and Ratings module cross links references by others to the information shared. For instance, more valuable responses will be cross linked/referred by others more often. In various embodiments, the plurality of reviews may be received in textual format (with or without a limit on number of characters), an audio format or a video format or any other acceptable format. Similar to the textual format, a limit may or may not be imposed on the size and duration etc. of the plurality of reviews in audio and video formats. In various other embodiments, multiple choice questions may be presented to the plurality of reviewers and responses to the multiple choice questions constitute a review. In an exemplary embodiment, the plurality of ratings may be received as selection of one or more indicia out of a predetermined number of indicia. For instance, the plurality of ratings may be received as a selection of one or more star values out of say five or ten star values. Further, a fraction of indicia such as a half or a quarter star values may also be selected. For another instance, ratings may be received as selection or deselection of a predefined token. In accordance with an embodiment, an average rating may be calculated as mean of the plurality of ratings assigned to the subject under review.

Further, the rating and ranking module is configured to rank the plurality of reviewers as a function of the plurality of reviews and the plurality of ratings received. The reviews can be positive reviews, negative reviews or neutral reviews. In accordance with an embodiment, a reviewer of the plurality of reviewers, providing maximum positive reviews is given a highest rank and subsequently lowest rank is given for maximum number of negative reviews. In another embodiment, a reviewer of the plurality of reviewers providing highest ratings is given a highest rank. In various other embodiments, various other factors are accounted for before the plurality of reviewers are ranked. The various other factors include, but are not limited to, educational qualifications of the plurality of reviewers, professional qualifications of the plurality of reviewers, prior knowledge of a subject under review of the plurality of reviewers, number of previous reviews posted and/or viewed by the plurality of reviewers and ability to find correctness in a review provided by another reviewer etc. Further, in various other embodiments, the plurality of reviewers is ranked either as a whole or subject wise. For example, a reviewer of the plurality of reviewers has a fourth rank with regards to one subject and a sixth rank with regards to another subject.

In accordance with an embodiment of the present invention, the rating and ranking module may further be configured to apply additional constraints to the plurality of reviewers. For instance, as a reviewer on plurality of occasions is allowed to provide a predetermined number (say 10) of reviews for a predetermined period of time (say one month). Additionally, in another embodiment, the reviewer may be allowed to provide reviews for a predetermined number of subjects (say 2). In various other embodiments, the rating and ranking module is configured to apply additional filters to the plurality of reviews. Further, the additional filters may inhibit providing of reviews with sole purpose of marketing of the subject under review.

Those of skill in the art will recognize that characteristics not disclosed herein are, in some embodiments, useful to determine if a vendor is qualified. In further or additional embodiments, the rating and/or one or more review scores of a vendor are based on reviews on the website of the host of the intermediary application configured to provide a reverse auction. In further or additional embodiments, the vendor rating, one or more review scores of a vendor are obtained from external review websites.

The set 200 may also include a verification module 210 which may configure the server 110 to perform authentication and authorization of the users and the service providers. For example, the verification module 210 may configure the server 110 to check the data records such as, profile reviews and ratings/rankings to authenticate the user to allow for posting the service request on the platform Similarly, the verification module 210 may further configure the server 110 to authenticate the service provider for placing a bid on the posted service based on profile reviews and ratings/rankings. The verification module 210 may also configure the server 110 to provide rights for authorization to services such as editing requirements, changing profiles and marking an auction close. That is, the verification module 210 performs the authorization process for the users and the service providers to allow transmission and receiving only the information that is allowed to be shared. For example, the verification module 210 may only allow the service provider to see his/her bid, while allowing the user to check bids from all the concerned service providers.

The set 200 may also include a notification module 212 which may configure the server 110 to notify the information about the service request, provided by the user, to all concerned service providers with selected bids. Further, the notification module 212 may configure the server 110 to notify the service provider about his/her selection as the winning bidder. In some examples, the set 200 may further include a communication module 214 which may configure the server 110 to provide a platform for the communication between the users and the service providers. Via this communication platform, the user may be able to directly communicate the specific requirements of the service and further negotiate on terms and conditions before finalizing the contract with the winning bidder. It may be contemplated that the communication platform may be an email or chat based platform or a discussion forum governed by system policies. The communication module 214 may include tools to maintain anonymity of the users and the service providers, as required. Further, the set 200 may include a payment module 216 which may configure the server 110 to make financial transactions, that is to exchange payment between the users and the service providers (winning bidder) after successful completion of the task based on the service requirement.

In an embodiment of the present disclosure, the set 200 may include an analysis module 218 which may configure the server 110 to perform smart searches of vendor/service providers that may suit the service requested by the user. This way, the server 110 may be able to find relevant service providers which may be experienced for carrying out the requested service based on their profile information; who in turn may be notified, through the notification module 212 by providing a participation request in the auction process. In one example, the analysis module 218 may further configure the server 110 to provide input to the user, such as, about add-on services that they might need in addition to the posted service, based on the service request and history. In other example, the analysis module 218 may further configure the server 110 to utilize the collected information to make smart decision and provide analytical feedback to the developers for improvement and optimization of the offerings on the reverse auction platform of the present disclosure.

Further, in an embodiment, the set 200 may include a cross-verification module 220. The cross-verification module 220 may configure the server 110 to verify the delivered product by the winning bidder. For this purpose, the cross-verification module 220 may configure the server 110 to select a panel of experts, either alone or in combination from the participating service providers and non-participating service providers if their profile information is found relevant to the service request. The cross-verification module 220 may provide tools for the selected panel to up-vote or down-vote the delivered product, where the up-vote may denote that the delivered product is satisfactory and down-vote may denote that the delivered product is unsatisfactory. Further, the cross-verification module 220 may configure the server 110 to allow the experts from the panel to provide comments and share thoughts on the delivered product. In one example, the cross-verification module 220 may provide points/credits to the experts based on their answers/feedback. Further, in one example, the reviews and rating module 208 may configure the server 110 to upgrade or downgrade the rating/ranking of the winning bidder based on the number of up-votes and down-votes received for the delivered product for the current service request.

In an embodiment, the set 200 may also include a dispute handling module 222. The dispute handling module 222 may configure the server 110 to monitor the response of the expert panel on the delivered product. If the percentage of down-votes exceeds more than a certain percentage of total votes by the experts, the delivered product may be marked as “unacceptable”. In such case, the dispute handling module 222 may configure the server 110 to reverse any payment made to the winning bidder for the service. Alternatively, the dispute handling module 222 may instruct to reverse a partial amount from the total payment based on negotiations between the user and the winning bidder.

Further, in an embodiment, the set 200 may include an automation module 224. The automation module 224 may configure the server 110 to match the requested service to old service requests. If a relatively close match is found, as defined by some criteria, the automation module 224 may provide the user with copy of the delivered product for the old service request for his/her reference and perusal. The automation module may also configure the server 110 to collect data and find trends about the posted service requests, delivered products, participation of service providers, etc., which in turn may be used by the developer for development of the auction platform, that is the computer system 100 of the present disclosure.

Embodiments of the present invention aim to provide a method for facilitating reverse auction comprising the steps of: obtaining plurality of pieces of information inputted by a user by an acquisition module; collecting plurality of bids provided by a plurality of service providers by a collection module; determining a lowest bid of said provided bids by said service providers by a control module; notifying the winning bidder by a notification module; receiving a communication between said user and said service provider by a communication module; and purchasing said bid by said user by means of payment module; wherein said user and said service provider are optionally connected by a server.

Embodiments of the present invention aim to provide a system for facilitating reverse auction process comprising: plurality of user; plurality of service providers; plurality of server configured to connect said user and said service provider; a set of module implemented by said server to perform reverse auction process comprising: an acquisition module to configure said server to obtain plurality of pieces of information inputted by said user; a collection module to configure said server to collect plurality of bids posted by said service providers, a communication module to configure said server to provide a platform for the communication between the users and the service providers; a control module to configure said server to determine the winner of the auction; a reviews and rating module to configure said server to rate said users and the service providers; a notification module to configure said server to notify the information about a service request, provided by said user, to all concerned service providers with selected bids; and a payment module to configure said server to make financial transactions.

The processing to be executed on the communication module can be implemented by using computer programs. These programs can be stored on a storage medium such as a floppy disk, an optical disk, or a hard disk, and can be distributed via a network.

The present disclosure, specifically, provides the computer system 100 that may be applicable to help the users for getting professional services via reverse auctioning, such as consultation services, or the like. The service providers may be professionals, such as doctors, teachers, lawyers, engineers, architects, management consultants, mathematicians, scholars, researchers, etc. In one example, the requested service may be in the form of questions posted pertaining to certain topics, such as a mathematical problem; and further the delivered product may be in the form of answers to the posted questions. In other example, the requested service may be in the form of a digital service, such as a digital design; and the delivered product may be in the form of a digital file. Further, in one example, the delivered product may be in the form of facts, references, derivatives, experiences, suggestions, options or anything that may be cross-examined and verifiable in certain context. However, it may be contemplated that the present disclosure may be applicable to other forms of services as well. In one example, the bid may be for government recognized currency, digital currency, coupons, barter things (physical or virtual) and/or favors.

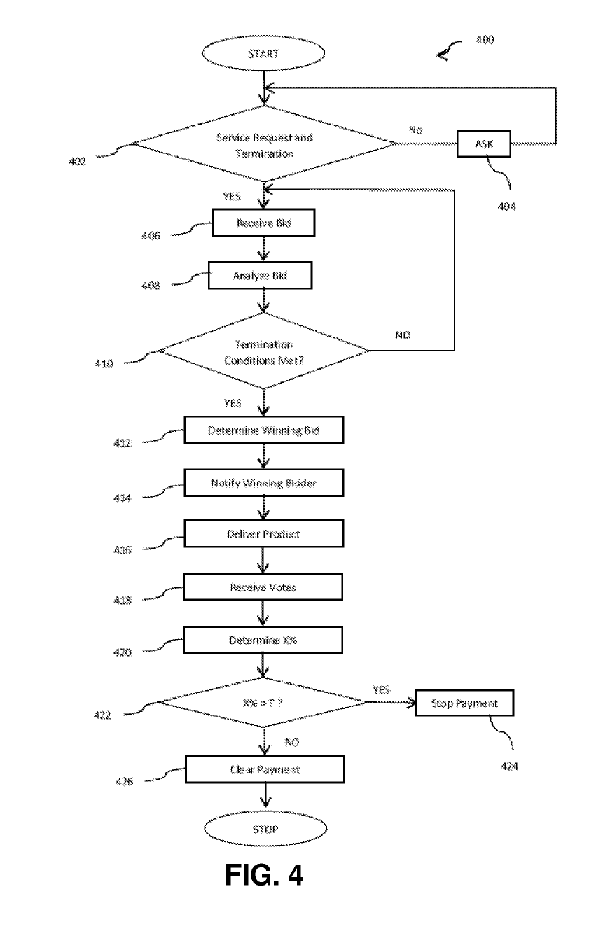

The present disclosure provides a method 400 for getting a service, as illustrated in the form of a flowchart in FIG. 4. As illustrated, in step 402, the method 400 includes checking whether all the details about the service request and termination conditions for the service request are properly defined by the user, as implemented by the server 110 by means of the acquisition module 202. It may be contemplated that the termination conditions may include, but not limited to, end date and time, minimum number of bids, etc. If “NO”, the method 400 may proceed to step 404 which involves asking the user to provide the necessary details, as implemented by the server 110 by means of the acquisition module 202. If “YES”, the method 400 may proceed to step 406 which involves receiving the bids by the service providers, as implemented by the server 110 by means of the collection module 204.

Further, in step 408, the method 400 includes computing and sorting the bids as lowest bid, bid from highest rated professional, bids with maximum conditions met, bids with additional conditions met, etc., as implemented by the server 110 by means of the control module 206. Further, in step 410, the method 400 includes checking whether the termination conditions for the service request as defined have been met, as implemented by the server 110 by means of the control module 206. If “NO”, the server 110 may keep receiving further bids till such conditions are met. If “YES”, as shown in step 412, the method 400 may include determining the winning bid, as implemented by the server 110 by means of the control module 206. Further, in step 414, the method 400 may include notifying the winning bidder, as implemented by the server 110 by means of the notification module 212. Subsequently, in step 416, the method 400 may include receiving the delivered product or answer by the user, from the service provider, as implemented by the server 110 by means of the communication module 214.

In step 418, the method 400 may include receiving votes for cross-verification of the answer; and in step 420, the method 400 may include determining the percentage of down-votes, represented by X %, out of the total votes, as implemented by the server 110 by means of the cross-verification module 220. In step 422, the method 400 may include checking if the percentage of down-votes exceeds a pre-determined threshold, represented by T, as implemented by the server 110 by means of the cross-verification module 220. If “YES”, in step 424, the method 400 may include stopping the payment to the winning bidder, as implemented by the server 110 by means of the payment module 216. If “NO”, in step 426, the method 400 may include releasing the payment to the winning bidder, as implemented by the server 110 by means of the payment module 216. In one example, the questioner may select from the list of reviewers registered or suggested by the reviews and rating module 208. In another example a verified document that is part of question or answer can be re-used for other questions without verification.

The computer system 100 of the present disclosure provides the advantage that the delivered product/answer is cross-verified. This assures the user of the quality of the delivered product/answer. Further, the present disclosure also ensures that the user is charged for payment only if the delivered product/answer is satisfactory, as decided by a panel of experts.

All aspects of the present system will be conducted by real-time, computer-network, and Internet-based data communication, and via electronic, digital automation, except only the need for human decision-making Among other things, the System includes facilitation of advanced electronic procurement flow and approval routing.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claim.

We claim:

1. A method for facilitating reverse auction comprising the steps of:
obtaining plurality of pieces of information inputted by a user by an acquisition module;
collecting plurality of bids provided by a plurality of service providers by a collection module;
determining a lowest bid of said provided bids by said service providers by a control module;
notifying the winning bidder by a notification module;
receiving a communication between said user and said service provider by a communication module; and
purchasing said bid by said user by a payment module;
wherein said user and said service provider are optionally connected by a server.

2. The method as claimed in claim 1, further comprising a step of interacting said user and said service provider with said server by a device.

3. The method as claimed in claim 1, wherein said method comprises a step of communicating said service providers and said users with each other in a peer-to-peer manner, over a network or on a communication interface.

4. The method as claimed in claim 1, further comprises a step of configuring said server to automatically bid for said service providers by collection module.

5. The method as claimed in claim 1, further comprises configuring said server to compute the condition for the bids that satisfies the minimum requirements acquired by the acquisition module by said control module.

6. The method as claimed in claim 1, further comprising a step of providing said user with the plurality of piece of bid information, from the participating service providers, satisfying the inputted conditions for the requested service by said control module.

7. The method as claimed in claim 1, further comprising a step of selecting by user said winning bidder from the plurality of service providers based on the shared pieces of information by the control module.

8. The method as claimed in claim 1, further comprising a step of selecting automatically said winning bidder based on the bid with the minimum price quote, as received from the plurality of service providers by said control module.

9. The method as claimed in claim 1, further comprising rating said users and the service providers based on their profile information and history on the platform by said server.

10. The method as claimed in claim 1, further comprising a step of authenticating and authorizing of the users and the service providers by a verification module implemented by the server.

11. The method as claimed in claim 10, configuring said server to provide rights for authorization to services such as editing requirements, changing profiles and marking an auction close by said verification module.

12. The method as claimed in claim 10, further comprising a step of performing said authorization process for the users and the service providers to allow transmission and receiving of information that is allowed to be shared by said verification module.

13. The method as claimed in claim 1, further comprising a step of communicating by said user to said winning service provider the specific requirements of the service by means of the communication module.

14. The method as claimed in claim 1, further comprising facilitating payment between the users and the service providers after successful completion of the task based on the service requirement by said payment module.

15. The method as claimed in claim 1, further comprising a step of performing smart searches of service providers that may suit the service requested by said user by an analysis module implemented by said server.

16. The method as claimed in claim 1, further comprising a step of verifying the delivered product or service by the winning bidder by a cross-verification module implemented by said server.

17. The method as claimed in claim 1, further comprising a step of monitoring a response of an expert panel on the delivered product by said service providers by a dispute handling module implemented by said server.

18. The method as claimed in claim 1, further comprising a step of matching a requested service to an old service requests by an automation module implemented by said server.

19. The method as claimed in claim 1 further comprising a step of determining said bids as lowest bid, bid from highest rated professional, bids with maximum conditions met, bids with additional conditions by said control module.

20. The method as claimed in claim 1 further comprising a step of receiving said bid from said service providers till the termination conditions for the service request by said collection module as defined by said user have been met which is checked by control module.

21. A system for facilitating reverse auction process comprising:
plurality of user;
plurality of service providers;
plurality of server configured to connect said user and said service provider;
a set of module implemented by said server to perform reverse auction process comprising:
an acquisition module to configure said server to obtain plurality of pieces of information inputted by said user;
a collection module to configure said server to collect plurality of bids posted by said service providers,
a communication module to configure said server to provide a platform for the communication between the users and the service providers;
a control module to configure said server to determine the winner of the auction;
a reviews and rating module to configure said server to rate said users and the service providers;
a notification module to configure said server to notify the information about a service request, provided by said user, to all concerned service providers with selected bids; and
a payment module to configure said server to make financial transactions.

22. The system as claimed in claim 21, wherein said system further comprises a device for said user and said service provider to interact with said server.

23. The system as claimed in claim 22, wherein said device includes personal computers, tablet computers, smartphones, PDAs, voice recognition devices, gaming devices or the like.

24. The system as claimed in claim 21, wherein said service providers and users communicate with each other in a peer-to-peer manner, over a network or on a communication module.

25. The system as claimed in claim 21, wherein said collection module configures said server to automatically bid for said service providers.

26. The System as claimed in claim 21, wherein said control module configures the server to compute the condition for the bids that satisfies the minimum requirements acquired by the acquisition module.

27. The system as claimed in claim 21, wherein system further comprising a processing unit, a system memory and a system bus.

28. The system as claimed in claim 21, wherein said control module is configured to provide said user with the plurality of piece of bid information, from the participating service providers, satisfying the inputted conditions for the requested service.

29. The system as claimed in claim 28, wherein the piece of information includes quoted bid price, experience of the service provider, reviews and ratings/rankings of the service provider and combination thereof.

30. The system as claimed in claim 21, wherein the user selects the winning bidder from the plurality of service providers based on the shared pieces of information by the control module.

31. The system as claimed in claim 21, wherein said control module is configured to automatically select said winning bidder based on the bid with the minimum price quote, as received from the plurality of service providers.

32. The system as claimed in claim 21, wherein said server rates said users and the service providers based on their profile information and history on the platform.

33. The system as claimed in claim 21, wherein said system further comprises a verification module to configure said server to perform authentication and authorization of the users and the service providers.

34. The system as claimed in claim 33, wherein said verification module configures said server to provide rights for authorization to services such as editing requirements, changing profiles and marking an auction close.

35. The system as claimed in claim 33, wherein said verification module is configured to perform said authorization process for the users and the service providers to allow transmission and receiving of information that is allowed to be shared.

36. The system as claimed in claim 21, wherein said user communicates to said winning service provider the specific requirements of the service.

37. The system as claimed in claim 21, wherein said payment module facilitates payment between the users and the service providers after successful completion of the task based on the service requirement.

38. The system as claimed in claim 21, wherein said system further comprises an analysis module to configure said server to perform smart searches of service providers that may suit the service requested by said user.

39. The system as claimed in claim 21, wherein said system further comprises a cross-verification module to configure said server to verify the delivered product by the winning bidder.

40. The system as claimed in claim 21, wherein said system further comprises a dispute handling module to configure said server to monitor the response of an expert panel on the delivered product by said service providers.

41. The system as claimed in claim 21, wherein said system further comprises an automation module to configure said server to match a requested service to an old service requests.

42. The system as claimed in claim 21, wherein said system further comprises a system memory which is selected from one or more memory devices such as RAM.

43. The system as claimed in claim 21, wherein said server includes a storage medium selected from a group of solid state storage device, a magnetic hard disk drive, a magnetic hard disk, a magnetic disk drive, an optical disk drive, a flash memory and combination thereof.

44. The system as claimed in claim 21, wherein control module is configured to determine said bids as lowest bid, bid from highest rated professional, bids with maximum conditions met, bids with additional conditions.

45. The system as claimed in claim 21, wherein said collection module is configured to receive said bid from the service providers till the termination conditions for the service request as defined by the user have been met which is checked by control module.

46. The system for facilitating reverse auction comprising:
a review and rating module configured to receive a plurality of reviews and ratings from a plurality of reviewers of plurality of users and service providers wherein said rating module sets a rank based on said plurality of reviews and ratings.

47. The system as claimed in claim 46, wherein said reviews can be positive, negative or neutral.

48. The system as claimed in claim 46, wherein said review and rating module is configured to set highest ranking to the maximum positive reviews.

49. The system as claimed in claim 46, wherein said reviews is based on a profile such as previous work, description, reputation, ranking, rating, review score(s), number of previous sales, payment methods accepted, condition of previously delivered items, location, speed of delivery, local delivery availability, local pickup availability, auxiliaries such as warranties and/or guarantees and combination thereof.
